(19) United States
(12) Patent Application Publication
(10) Pub. No.: US 2019/0394495 A1
(43) Pub. Date: Dec. 26, 2019

(54) IMAGING ELEMENT, AND IMAGING DEVICE AND METHOD

(71) Applicant: SONY CORPORATION, Tokyo (JP)

(72) Inventors: Toshinori IHARA, Tokyo (JP); Takefumi NAGUMO, Kanagawa (JP)

(73) Assignee: SONY CORPORATION, Tokyo (JP)

(21) Appl. No.: 16/483,920

(22) PCT Filed: Mar. 14, 2018
(86) PCT No.: PCT/JP2018/010080

§ 371 Date: Aug. 6, 2019

(30) Foreign Application Priority Data
Mar. 27, 2017 (JP) 2017-060412

(51) Int. Cl. H04N 19/91; H04N 5/369

(52) U.S. Cl. CPC H04N 19/91; H04N 5/369

(57) ABSTRACT

The present disclosure relates to an imaging element enabling fixed-length compression of image data while avoiding generation of a prohibition code, and an imaging device and method. Image data obtained in a light reception unit that receives incident light and performs photoelectric conversion is Golomb-encoded, and is compressed into encoded data not including a prohibition code by adding an inverse code of encoded data of bit 1 to an LSB. The present disclosure can be applied to an imaging device.

### TECHNICAL FIELD

The present disclosure relates to an imaging element, and an imaging device and method, and more particularly to an imaging element enabling fixed-length compression of image data while avoiding generation of a prohibition code, and an imaging device and method.

### BACKGROUND ART

In the related art, there is one in which a semiconductor substrate on which a light reception unit that photoelectrically converts incident light is formed is sealed to be modularized as an imaging element (image sensor).

Such a modularized imaging element photoelectrically converts incident light, generates image data, outputs the image data in a non-compressed state (for example, as a RAW data), and transmits the image data to a main substrate.

There has been proposed a technique for reducing an output interface band by image compression in such a stacked image sensor (refer to Patent Literature 1).

### CITATION LIST

### Patent Literature

Patent Literature 1: JP-A-2014-103543

### DISCLOSURE OF INVENTION

### Technical Problem

However, in the technique according to Patent Literature 1, since it is not guaranteed that a prohibition code does not exist in the data after image compression, existing fixed-length image compression cannot be applied as it is, in output interface having the prohibition code in some cases.

The present disclosure has been made in view of such a situation, and particularly, is to enable fixed-length compression of image data while avoiding generation of a prohibition code.

### Solution to Problem

According to one aspect of the present disclosure, there is provided an imaging element including: a light reception unit that receives incident light and performs photoelectric conversion; and a compression unit that compresses image data obtained in the light reception unit into encoded data not including a prohibition code in which identical codes of which number is more than a predetermined number are consecutively arranged.

The compression unit may compress the image data and add a dummy bit to compress the image data into the encoded data not including the prohibition code in which the identical codes of which number is more than a predetermined number are consecutively arranged.

The image data may be a set of pixel data items obtained in each unit pixel of the light reception unit, and the compression unit may perform Golomb encoding of a difference value between the pixel data items and add the dummy bit to compress the image data into the encoded data not including the prohibition code.

The compression unit may compress the image data at a fixed compression rate and add the dummy bit to compress the image data into the encoded data not including the prohibition code.

The image data may be a set of pixel data items obtained in each unit pixel of the light reception unit, and the compression unit may compress the image data into the encoded data not including the prohibition code by one of Golomb encoding of a difference value between the pixel data items or inverse Golomb encoding of encoding the difference value between the pixel data items to an inverse code for the Golomb encoding on the basis of the encoded data encoded by immediately preceding encoding among the pixel data items.

The compression unit may compress the difference value between the pixel data items into the encoded data not including the prohibition code according to one of the Golomb encoding or the inverse Golomb encoding on the basis of a value of a predetermined bit of the encoded data encoded by immediately preceding encoding among the pixel data items.

The predetermined bit may be a least significant bit (LSB) or a most significant bit (MSB).

In a case where predetermined bits of the encoded data of the difference value between the pixel data items encoded by immediately preceding encoding are identical values being consecutive a predetermined number of times, when the Golomb encoding is performed on the difference value between the immediately preceding pixel data items, the compression unit may perform the inverse Golomb encoding, and when the inverse Golomb encoding is performed on the difference value between the immediately preceding pixel data items, the compression unit may perform, the Golomb encoding to compress the difference value into the encoded data not including the prohibition code.

The prohibition code may be a code included in the encoded data, in which 1's or 0's of which number is more than a predetermined number is consecutive.

According to one aspect of the present disclosure, there is provided an imaging method of an imaging element, including a step of compressing image data obtained in a light reception unit that receives incident light and performs photoelectric conversion into encoded data not including a prohibition code in which identical codes of which number is more than a predetermined number are consecutively arranged.

According to one aspect of the present disclosure, there is provided an imaging device including: an imaging element including a light reception unit that receives incident light and performs photoelectric conversion, and a compression unit that compresses image data obtained in the light reception unit into encoded data not including a prohibition code in which identical codes of which number is more than a predetermined number are consecutively arranged; and a decompression unit that decompresses the encoded data that is output from the imaging element and obtained by compressing the image data by the compression unit.

The compression unit may compress the image data and add a dummy bit to compress the image data into the encoded data not including the prohibition code in which the identical codes of which number is more than a predetermined number are consecutively arranged.

The image data may be a set of pixel data items obtained in each unit pixel of the light reception unit, and the compression unit may perform Golomb encoding of a difference value between the pixel data items and add the dummy bit to compress the image data into the encoded data not including the prohibition code.

The compression unit may compress the image data at a fixed compression rate and add the dummy bit to compress the image data into the encoded data not including the prohibition code.

The image data may be a set of pixel data items obtained in each unit pixel of the light reception unit, and the compression unit may compress the image data into the encoded data not including the prohibition code by one of Golomb encoding of a difference value between the pixel data items or inverse Golomb encoding of encoding the difference value between the pixel data items to an inverse code for the Golomb encoding on the basis of the encoded data encoded by immediately preceding encoding among the pixel data items.

The compression unit may compress the difference value between the pixel data items into the encoded data not including the prohibition code according to one of the Golomb encoding or the inverse Golomb encoding on the basis of a value of a predetermined bit of the encoded data encoded by immediately preceding encoding among the pixel data items.

The predetermined bit may be a least significant bit (LSB) or a most significant bit (MSB).

In a case where predetermined bits of the encoded data of the difference value between the pixel data items encoded by immediately preceding encoding are identical values being consecutive a predetermined number of times, when the Golomb encoding is performed on the difference value between the immediately preceding pixel data items, the compression unit may perform the inverse Golomb encoding, and when the inverse Golomb encoding is performed on the difference value between the immediately preceding pixel data items, the compression unit may perform the Golomb encoding to compress the difference value into the encoded data not including the prohibition code.

The prohibition code may be a code included in the encoded data, in which 1's or 0's of which number is more than a predetermined number is consecutive.

According to one aspect of the present disclosure, there is provided an imaging method of an imaging device, including a step of decompressing encoded data that is output from an imaging element and obtained by compressing image data by a compression unit, in which the imaging element includes, a light reception unit that receives incident light and performs photoelectric conversion, and the compression unit that compresses the image data obtained in the light reception unit into the encoded data not including a prohibition code in which identical codes of which number is more than a predetermined number are consecutively arranged.

According to one aspect of the present disclosure, incident light is received, photoelectric conversion is performed, and image data obtained by the photoelectric conversion is compressed into encoded data not including a prohibition code in which the identical codes of which number is more than a predetermined number are consecutively arranged.

### Advantageous Effects of Invention

According to one aspect of the present disclosure, particularly, fixed-length compression of image data is possible while avoiding generation of a prohibition code.

### BRIEF DESCRIPTION OF DRAWINGS

FIG. 1 is a diagram illustrating an example of a configuration of an imaging element and an image processing device of the present disclosure.

FIG. 2 is a diagram illustrating an example of a configuration of a first embodiment of a compression unit of FIG. 1.

FIG. 3 is a diagram illustrating a process of the compression unit of FIG. 2.

FIG. 4 is a diagram illustrating an example of a configuration of a first embodiment of a decompression unit of FIG. 1.

FIG. 5 is a flowchart illustrating an imaging process by an imaging element of the present disclosure.

FIG. 6 is a flowchart illustrating a compression process of FIG. 5.

FIG. 7 is a flowchart illustrating a Golomb encoding process of FIG. 6.

FIG. 8 is a diagram illustrating the Golomb encoding process of FIG. 6.

FIG. 9 is a flowchart illustrating image processing of the image processing device of the present disclosure.

FIG. 10 is a flowchart illustrating a decompression process of FIG. 9.

FIG. 11 is a diagram illustrating an example of a configuration of a second embodiment of the compression unit of FIG. 1.

FIG. 12 is a diagram illustrating an inverse Golomb encoding process of FIG. 11.

FIG. 13 is a diagram illustrating the inverse Golomb encoding process of FIG. 11.

FIG. 14 is a diagram illustrating an example of a configuration of a second embodiment of the decompression unit of FIG. 1.

FIG. 15 is a flowchart illustrating a compression process by the compression unit of FIG. 11.

FIG. 16 is a flowchart illustrating an inverse Golomb encoding process of FIG. 15.

FIG. 17 is a flowchart illustrating a decompression process by the decompression unit of FIG. 14.

FIG. 18 is a block diagram illustrating an example of a configuration of an imaging device as an electronic apparatus to which an imaging element of the present disclosure is applied.

FIG. 19 is a diagram illustrating a usage example of an imaging element to which the technology of the present disclosure is applied.

### MODE(S) FOR CARRYING OUT THE INVENTION

Hereinafter, favorable embodiments of the present disclosure will be described in detail with reference to the accompanying drawings. Note that in the present specification and the drawings, components having substantially the same functional configuration will be denoted by the same reference numerals, and redundant description will be omitted.

Hereinafter, modes (hereinafter referred to as embodiments) for carrying out the present disclosure will be described. Note that the description will be made in the following order.

1. First Embodiment

2. Second Embodiment

3. Application Example to Electronic Apparatus

4. Example of Solid-State Imaging Device

### 1. First Embodiment

### Imaging Element

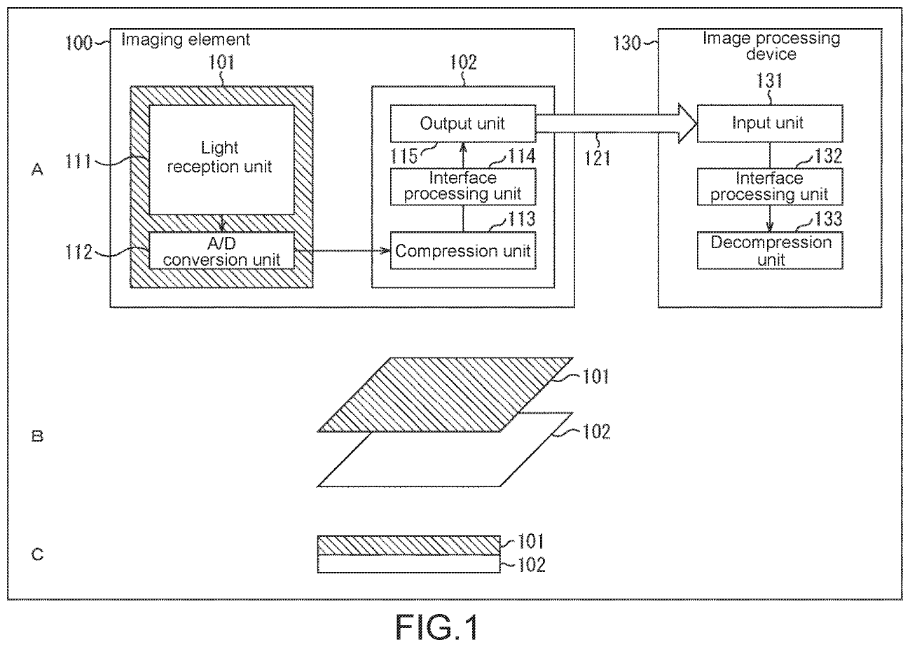

FIG. 1 is a block diagram illustrating an example of a main configuration of an imaging element to which the present technology is applied. An imaging element 100 illustrated in FIG. 1 is an image sensor that captures an image of an object, obtains a digital data (image data) of the captured image, and outputs the image data. The imaging element 100 is an arbitrary image sensor and may be an image sensor or the like using, for example, a complementary metal oxide semiconductor (CMOS) or a charge coupled device (CCD).

As illustrated in A of FIG. 1, the imaging element 100 includes a semiconductor substrate 101 indicated by hatching and a semiconductor substrate 102 indicated in white. The semiconductor substrate 101 and the semiconductor substrate 102 are sealed in an overlapped state as illustrated in B of FIG. 1 and modularized (integrated).

That is, as illustrated in C of FIG. 1, the semiconductor substrate 101 and the semiconductor substrate 102 form a multilayer structure (stacked structure). Circuits formed on the semiconductor substrate 101 and circuits formed on the semiconductor substrate 102 are connected to each other by vias or the like.

As described above, the imaging element 100 is a module (also referred to as a large scale integration (LSI)) chip in which the semiconductor substrate 101 and the semiconductor substrate 102 are integrated so as to constitute a multilayer structure. With the semiconductor substrate 101 and the semiconductor substrate 102 constituting a multilayer structure in such a manner inside the module, the imaging element 100 can realize mounting of a larger scale circuit without increasing the size of the semiconductor substrate. That is, the imaging element 100 can mount a larger scale circuit while suppressing an increase in cost.

As illustrated in A of FIG. 1, a light reception unit 111 and an A/D conversion unit 112 are formed on the semiconductor substrate 101. In addition, a compression unit 113, an interface processing unit 114, and an output unit 115 are formed on the semiconductor substrate 102.

The light reception unit 111 receives incident light and performs photoelectric conversion. The light reception unit 111 has a plurality of unit pixels, each of which has a photoelectric conversion element such as a photodiode. By photoelectric conversion, charges corresponding to the incident light are accumulated in each unit pixel. The light reception unit 111 supplies the charges accumulated in each unit pixel to the A/D conversion unit 112 as an electric signal (pixel signal).

The A/D conversion unit 112 A/D-converts each pixel signal supplied from the light reception unit 111 to generate a pixel data items as a digital data. The A/D conversion unit 112 supplies a set of the pixel data items of the unit pixels generated in such a manner to the compression unit 113 as image data. That is, a RAW data before being subjected to demosaic processing is supplied to the compression unit 113.

The compression unit 113 compresses the image data (RAW data) supplied from the A/D conversion unit 112 according to a predetermined method to generate encoded data. The data amount of the encoded data is smaller than that of the image data before compression. That is, the compression unit 113 reduces the data amount of the image data.

As illustrated in FIG. 1, the compression unit 113 is mounted in the imaging element 100. That is, the compression unit 113 is implemented as a circuit incorporated in the imaging element 100 or as software executed inside the imaging element 100. For this reason, the compression method by the compression unit 113 is basically arbitrary, but as described above, the compression method needs to be able to be mounted in the imaging element 100 (in the module).

As a representative compression method of the image data, for example, there are Joint Photographic Experts Group (JPEG) and Moving Picture Experts Group (MPEG). These compression methods are advanced methods, and processing of the compression methods is complicated and also the circuit size is large, and the manufacturing cost of the imaging element 100 is likely to increase. For this reason, generally, it is difficult to mount such an advanced compression method in the imaging element 100 as a circuit or software. In addition, even if the compression method is mounted, some non-practical cases such as a case where a processing time (number of clocks) becomes long, the delay time is likely to increase, and thus an encoding process is too late for a frame rate may also be considered. Furthermore, a case where a compression rate does not contribute to the reduction of the number of pins or the bus bandwidth because of the best effort may also be considered.

Therefore, the compression unit 113 performs compression of the image data by a method being simpler in processing and having a shorter processing time (number of clocks) than an advanced compression method such as JPEG or MPEG, and being mountable in at least the imaging element 100 (in the module, particularly, the semiconductor substrate 102, together with the semiconductor substrate 101 having the light reception unit 111, constituting a stacked structure). Hereinafter, such compression is also referred to as simplified compression. That is, the compression unit 113 generates the encoded data by performing simplified compression of the image data (RAW data) supplied from the A/D conversion unit 112.

The specific compression method of the simplified compression is basically arbitrary as long as the above-mentioned condition is satisfied. For example, the method may be a reversible method or an irreversible method. However, generally, if the size of the semiconductor substrate 102 is set to be large, the cost increases. In addition, if the processing time (number of clocks) becomes long, the delay time increases. Therefore, it is desirable to apply a method being simpler in processing and having a shorter processing time to the simplified compression.

For example, generally, the A/D conversion unit 112 arranges pixel data items (image data) of each unit pixel in a one-dimensional shape in a predetermined order (as a pixel data items string) and supplies the image data to the compression unit 113. At the time of compression, if it is necessary to buffer (hold) the image data, there is a concern that the processing time is increased accordingly. For this reason, it is desirable to apply a method capable of sequentially compressing the image data (pixel data items string) supplied from the A/D conversion unit 112 without buffering the image data as much as possible to the simplified compression. For example, a compression method using differential pulse code modulation (DPCM) or a compression method using one-dimensional discrete cosine transformation (DCT) can be applied to the simplified compression.

Of course, with the improvement of the integration degree or the like, if the method can be mounted in the imaging element 100 at a low cost and a high-speed operation can be performed so that the delay time is within an allowable range, and a sufficient compression rate can be obtained, an advanced compression method such as JPEG or MPEG may be applied as the compression method of the compression unit 113.

The compression unit 113 supplies the encoded data obtained by the simplified compression of the image data to the interface processing unit 114.

When outputting the encoded data to an image processing device 130, the interface processing unit 114 converts the encoded data into a format according to I/O cells, I/O pins, and the like used for outputting and outputs the converted encoded data to the output unit 115.

The output unit 115 is configured with, for example, I/O cells, I/O pins, and the like and outputs the encoded data supplied through the interface processing unit 114 from the compression unit 113 to the outside of the imaging element 100. The encoded data output from the output unit 115 is supplied via a bus 121 to the input unit 131 of the image processing device 130.

The image processing device 130 is a device that performs image processing on the image data obtained by the imaging element 100. As illustrated in A of FIG. 1, the image processing device 130 includes an input unit 131, an interface processing unit 132, and a decompression unit 133.

The input unit 131 receives encoded data transmitted via the bus 121 from the imaging element 100 (the output unit 115). The input unit 131 supplies the acquired encoded data to the interface processing unit 132.

The interface processing unit 132 has a configuration corresponding to the interface processing unit 114, restores the encoded data converted into the format according to the I/O cells, the I/O pins, and the like to the original format, and supplies the restored encoded data to the decompression unit 133.

The decompression unit 133 decompresses the encoded data supplied from the input unit 131 through the interface processing unit 132 by a method corresponding to the compression method of the compression unit 113 and restores the image data. That is, the decompression unit 133 decompresses the encoded data supplied from the input unit 131 through the interface processing unit 132 by a method corresponding to the simplified compression by the compression unit 113 and restores the image data. The restored image data is, for example, image-processed, stored, or displayed as an image by the image processing device 130 or the like.

As described above, in a module (in an LSI chip), the imaging element 100 compresses the image data obtained by the light reception unit 111 to reduce the data amount and outputs a data having a reduced data amount. Therefore, since the bandwidth necessary for transmitting the image data (encoded data) of the bus 121 is reduced, the imaging element 100 can output a larger-capacity data at a higher speed without changing the bandwidth of the bus 121. That is, the imaging element 100 can output a larger-capacity data at a higher speed without increasing the number of I/O cells or I/O pins of the output unit 115, that is, without increasing the cost.

In other words, the imaging element 100 can suppress the influence of limitation of the bandwidth of the bus 121, and it is possible to improve the imaging performance such as high resolution of images, speeding up of processes from imaging to recording of still images, increasing of continuous shooting number and continuous shooting speed, speeding up of frame rates of moving images, or capturing of moving images and still images without increasing the cost (without increasing the number of I/O cells or I/O pins of the output unit 115).

### Compression Unit

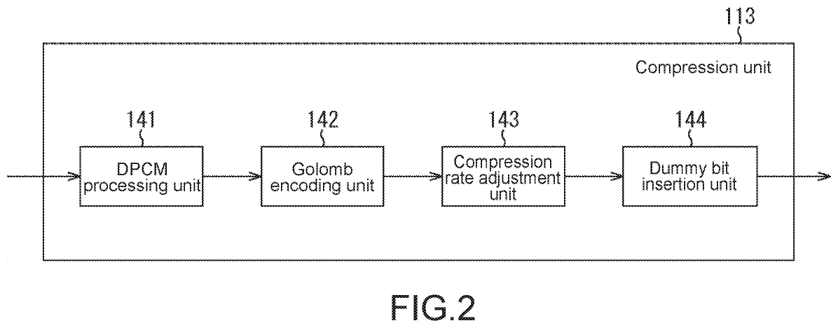

FIG. 2 is a block diagram illustrating an example of a main configuration of the compression unit 113 of FIG. 1. The compression unit 113 includes a DPCM processing unit 141, a Golomb encoding unit 142, and a compression rate adjustment unit 143.

The DPCM processing unit 141 calculates a difference value (hereinafter, also referred to as a residual difference) between consecutive pixel data items of the image data (pixel data items string aligned in one dimension) supplied from the A/D conversion unit 112. The DPCM processing unit 141 supplies each calculated difference value to the Golomb encoding unit 142.

The Golomb encoding unit 142 encodes each difference value supplied from the DPCM processing unit 141 to a Golomb code. The Golomb encoding unit 142 supplies the Golomb code (encoded data) to the compression rate adjustment unit 143.

The compression rate adjustment unit 143 adjusts a compression rate of the encoded data supplied from the Golomb encoding unit 142 to convert the compression rate into a predetermined compression rate. As a result, the encoded data is obtained by compressing the image data obtained by the light reception unit 111 at a predetermined compression rate. The compression rate may be set to be variable. However, since the maximum transmittable bandwidth of the bus 121 is fixed by a hardware factor, it is desirable that the compression rate is set to be fixed. The compression rate adjustment unit 143 outputs the encoded data, of which compression rate has been adjusted, to a dummy bit insertion unit 144.

With such a configuration, the compression unit 113 can perform the simplified compression of the image data (RAW data).

Note that, generally, in some cases, two-dimensional discrete cosine transformation may be used in image compression or the like. However, in comparison with one-dimensional discrete cosine transformation, there is a concern that the two-dimensional discrete cosine transformation is complicated in processing, and the circuit size increases. In comparison with the case of performing the two-dimensional discrete cosine transformation, by performing the one-dimensional discrete cosine transformation on the image data, it is possible to easily obtain a transformed data. That is, it is possible to suppress an increase in the circuit size of the compression unit 113.

The dummy bit insertion unit 144 inserts a dummy bit for generating a simplified-compressed encoded data with a fixed length while suppressing generation of a prohibition code.

The prohibition code is, for example, a code in which more than a predetermined number of consecutive 0's are included in encoded data in a binary code or a code in which more than a predetermined number of consecutive 1's are included in encoded data. Therefore, in encoded data not including a prohibition code, consecutive 0's or 1's of which number is smaller than the predetermined number are arranged.

The dummy bit insertion unit 144 inserts a dummy bit into the encoded data so that such a prohibition code is not generated and outputs the dummy-bit inserted encoded data to the interface processing unit 114.

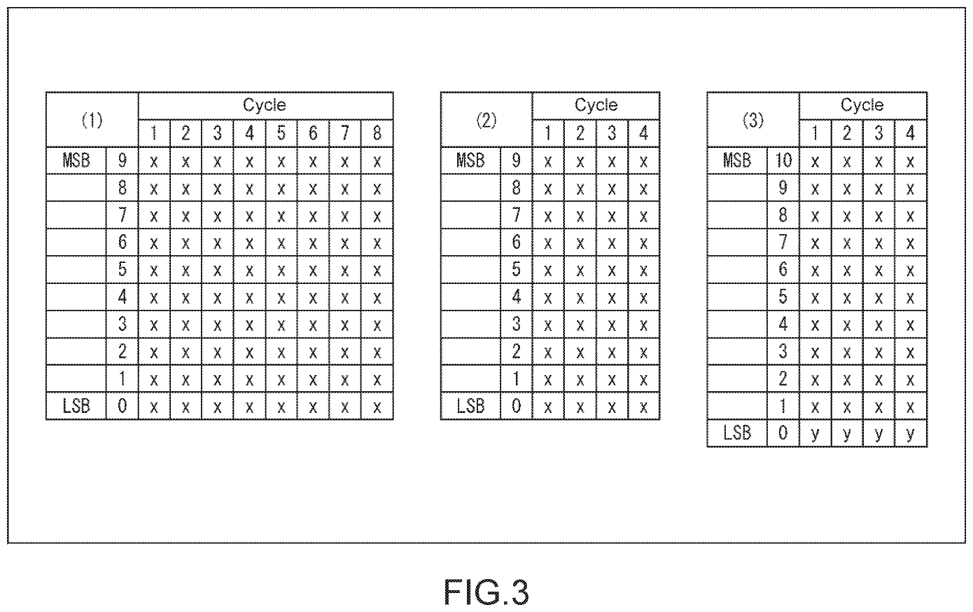

More specifically, for example, it is assumed that there are a total of 80 bits of image data of 8 pixels configured with 10-bit data per pixel as illustrated in the left portion of FIG. 3. It is guaranteed in advance that no prohibition code is generated in the image data.

In the case of the left portion of FIG. 3, the prohibition code is, for example, a code in which all bits of from the most significant bit (MSB) to the least significant bit (LSB) represented in cycle 1 are 1's or 0's. However, as a matter of coarse, there are various definitions of the prohibition code. In addition, a code in which all bits are not necessarily 1's or 0's may be a prohibition code. For example, as a code in which there are a predetermined number or more of consecutive 1's or 0's, for example, a code in which there are eight or more of consecutive 1's or 0's or a code in which there are nine of consecutive 1's or 0's may be defined as the prohibition code.

Furthermore, in FIG. 3, data of eight pixels are represented as the image data of one cycle for one pixel as cycles 1 to 8 in the horizontal direction in the figure, and pixel data items of each pixel is represented by 10 bits of from the LSB to the MSB in the vertical direction in the figure. Furthermore, each value is “x” and is any one of 0 and 1.

It is assumed that the image data in the left portion of FIG. 3 is compressed with 50% to generate a 40-bit encoded data, for example, as illustrated in the central portion of FIG. 3. In this case, it is not guaranteed that, by compression, a 10-bit coding or code of the LSB to the MSB of any cycle does not become a prohibition code. For this reason, there is a possibility that a prohibition code occurs in the encoded data.

Therefore, as illustrated in the right portion of FIG. 3, the dummy bit insertion unit 144 inserts a dummy bit configured with the inverted value of the code of bit 0 in the encoded data illustrated in the central portion of FIG. 3 into the LSB. In FIG. 3, each is represented by a value configured with “y”. That is, in FIG. 3, the value “y” of the LSB bit is an inverted code of the code represented by “x” of bit 1.

As a result, in the encoded data in the right portion of FIG. 3, since all bits are prevented from becoming 0 or 1 in any cycle, it is guaranteed that a prohibition code where all 11 bits are 1 or 0 is not generated. Furthermore, the bit position into which the dummy bit is inserted is not limited to the LSB as long as it is guaranteed that no prohibition code is generated. But, the bit position into which the dummy bit is inserted may be other bit positions and may be, for example, the MSB.

### Decompression Unit

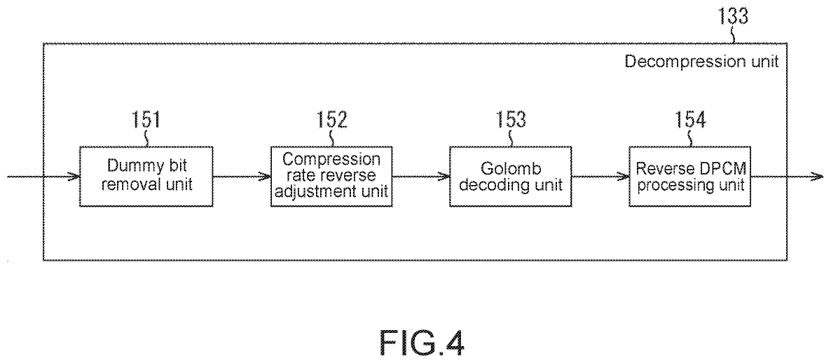

FIG. 4 is a block diagram illustrating an example of a main configuration of the decompression unit 133. The decompression unit 133 decompresses the encoded data by a method corresponding to the method of the compression unit 113 in the example of FIG. 2. As illustrated in FIG. 4, the decompression unit 133 in this case includes a dummy bit removal unit 151, a compression rate reverse adjustment unit 152, a Golomb decoding unit 153, and an reverse DPCM processing unit 154.

The dummy bit removal unit 151 removes the dummy bit inserted into the encoded data supplied from the input unit 131 and supplies the dummy-bit removed encoded data to the compression rate reverse adjustment unit 152.

The compression rate reverse adjustment unit 152 performs a reverse process of the process of the compression rate adjustment unit 143 on the encoded data, from which the dummy bits supplied from the dummy bit removal unit 151 have been removed, to restore the Golomb code generated by the Golomb encoding unit 142. The compression rate reverse adjustment unit 152 supplies the restored Golomb code to the Golomb decoding unit 153.

The Golomb decoding unit 153 decodes the Golomb code supplied from the compression rate reverse adjustment unit 152 by a method corresponding to the encoding method of the Golomb encoding unit 142 to restore the difference value (residual difference) generated by the DPCM processing unit 141. The Golomb decoding unit 153 supplies the restored difference value (residual difference) to the reverse DPCM processing unit 154.

The reverse DPCM processing unit 154 performs a reverse DPCM process (a reverse process of the DPCM performed by the DPCM processing unit 141) on the difference value (residual difference) supplied from the Golomb decoding unit 153 to restore each pixel data items. The reverse DPCM processing unit 154 outputs a set of the restored pixel data items to the outside of the decompression unit 133 as image data.

With such a configuration, the decompression unit 133 can correctly decode the encoded data generated by the compression unit 113. That is, the decompression unit 133 can realize the simplified compression of the image data (RAW data).

### Imaging Process

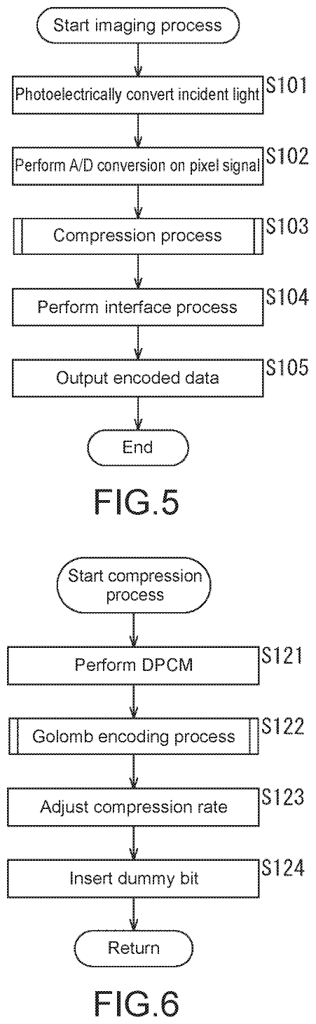

Next, the imaging process performed by the imaging element 100 of FIG. 1 will be described with reference to the flowchart of FIG. 5.

The imaging process is performed when the imaging element 100 captures an image of an object and obtains image data of the image of the object.

When the imaging process is started, in step S101, the light reception unit 111 photoelectrically converts incident light in each unit pixel of an effective pixel area.

In step S102, the A/D conversion unit 112 A/D-converts the pixel signal (analog data) of each unit pixel obtained by the process of step S101.

In step S103, the compression unit 113 executes a compression process to compress the image data, which is a set of the pixel data items as digital data, obtained by the process of step S102 to generate encoded data. Furthermore, the compression process will be described later in detail with reference to FIG. 6.

In step S104, the interface processing unit 114 performs an interface process on the encoded data to convert the encoded data into a format suitable for transmission and outputs the interface-processed encoded data to the output unit 115.

In step S105, the output unit 115 outputs the interface-processed encoded data obtained by the process of step S104 to the outside (bus 121) of the imaging element 100.

When the process of step S105 ends, the imaging process ends.

### Compression Process

Next, the compression process performed in step S103 of FIG. 5 will be described with reference to the flowchart of FIG. 6.

When the compression process is started, in step S121, the DPCM processing unit 141 of FIG. 2 performs a DPCM process on the image data to obtain a difference value between the pixel data items which is consecutive in the processing order.

In step S122, the Golomb encoding unit 142 performs a Golomb encoding process to perform Golomb encoding using each difference value (residual difference) obtained by the process of step S121.

### Golomb Encoding Process

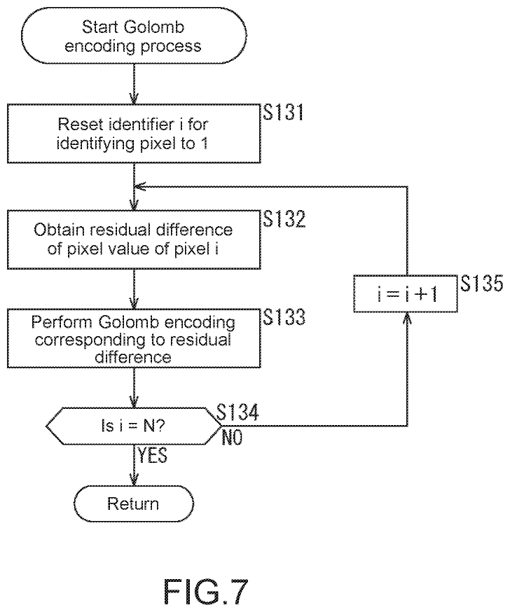

Herein, the Golomb encoding process will be described with reference to the flowchart of FIG. 7.

In step S131, the Golomb encoding unit 142 resets an identifier i for identifying a pixel to 1 with respect to the data with the difference value (residual difference) for each pixel obtained by the DPCM process.

In step S132, the Golomb encoding unit 142 reads out the difference value (residual difference) of the pixel of the pixel i to be processed, which is obtained by the DPCM process.

In step S133, the Golomb encoding unit 142 performs Golomb encoding corresponding to the difference value (residual difference).

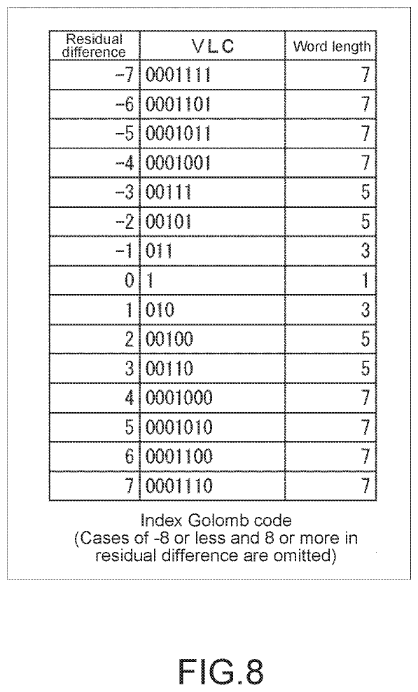

More specifically, for example, as illustrated in FIG. 8, in a case where the difference value (residual difference) is 0, the Golomb encoding unit 142 encodes the Golomb code (VLC) to “1” having a word length of 1.

In addition, in a case where the difference value (residual difference) is 1, the Golomb encoding unit 142 encodes the Golomb code (VLC) to “010” having a word length of 3. Similarly, in a case where the difference value (residual difference) is 2, the Golomb encoding unit 142 encodes the Golomb code (VLC) to “00100” having a word length of 5; in a case where the difference value (residual difference) is 3, the Golomb encoding unit 142 encodes the Golomb code (VLC) to “00110” having a word length of 5; in a case where the difference value (residual difference) is 4, the Golomb encoding unit 142 encodes the Golomb code (VLC) to “0001000” having a word length of 7; in a case where the difference value (residual difference) is 5, the Golomb encoding unit 142 encodes the Golomb code (VLC) to “0001010” having a word length of 7; in a case where the difference value (residual difference) is 6, the Golomb encoding unit 142 encodes the Golomb code (VLC) to “0001100” having a word length of 7; and in a case where the difference value (residual difference) is 7, the Golomb encoding unit 142 encodes the Golomb code (VLC) to “0001110” having a word length of 7.

In addition, in a case where the difference value (residual difference) is −1, the Golomb encoding unit 142 encodes the Golomb code (VLC) to “011” having a word length of 3; in a case where the difference value (residual difference) is −2, the Golomb encoding unit 142 encodes the Golomb code (VLC) to “00101” having a word length of 5; in a case where the difference value (residual difference) is −3, the Golomb encoding unit 142 encodes the Golomb code (VLC) to “00111” having a word length of 5; in a case where the difference value (residual difference) is −4, the Golomb encoding unit 142 encodes the Golomb code (VLC) to “0001001” having a word length of 7; in a case where the difference value (residual difference) is −5, the Golomb encoding unit 142 encodes the Golomb code (VLC) to “0001011” having a length of 7; in a case where the difference value (residual difference) is −6, the Golomb encoding unit 142 encodes the Golomb code (VLC) to “00 01101” having a length of 7; and in a case where the difference value (residual difference) is −7, the Golomb encoding unit 142 encodes the Golomb code (VLC) to “0001111” having a word length of 7. Furthermore, in FIG. 8, the encoded data of which difference value (residual difference) is larger than 8 and the encoded data of which difference value is smaller than −8 are omitted.

In step S134, the Golomb encoding unit 142 determines whether or not the identifier i is the number N of pixels. In a case where the identifier i is not the number N of pixels, the process proceeds to step S135.

In step S135, the Golomb encoding unit 142 increments the identifier i by 1, and the process returns to step S132. That is, the processes of steps S132 to S135 are repeated until the conversion to the Golomb codes corresponding to the difference values (residual differences) is completed all the pixels.

Then, in a case where it is determined in step S134 that the identifier i is the number N of pixels, the process ends.

By the above processes, the Golomb encoding according to the difference value (residual difference) is performed on all the pixels.

Herein, the description returns to the flowchart of FIG. 6.

In step S123, the compression rate adjustment unit 143 adjusts the compression rate of the encoded data by, for example, adding a data to the Golomb code obtained by the process of step S122.

When the encoded data with a predetermined compression rate is obtained for the image data input to the compression unit 113 by the process of step S123, the process proceeds to step S124.

In step S124, the dummy bit insertion unit 144 inserts a dummy bit into the encoded data. That is, the dummy bit insertion unit 144 generates the inverse code of the LSB of the encoded data as a dummy bit and inserts the dummy bit as a new LSB. By the process, the generation of the prohibition code in the encoded data is suppressed. By the above processes, the compression process ends, and the process returns to FIG. 5.

As described above, by executing each process, the imaging element 100 can perform the fixed-length compression of a higher-capacity data at a higher speed without increasing a cost, and thus, imaging performance can be improved.

In addition, the dummy bit is provided, so that it is possible to suppress the generation of the prohibition code.

### Image Processing

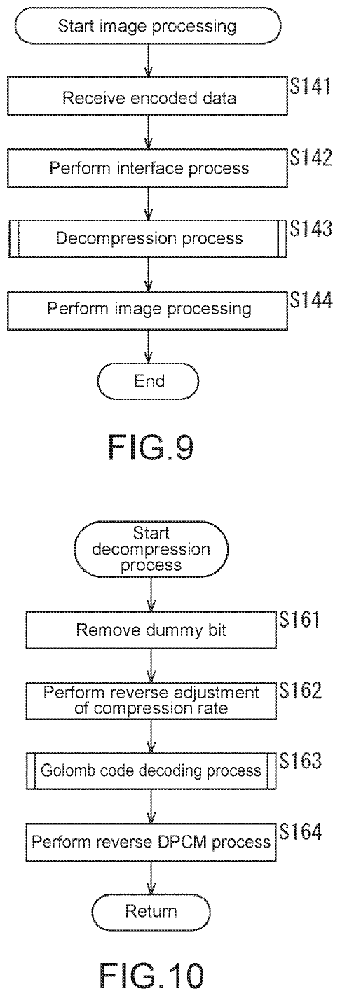

Next, image processing performed by the image processing device 130 of FIG. 1 will be described with reference to the flowchart of FIG. 9.

The image processing is performed when the image processing device 130 processes the encoded data output from the imaging element 100.

When the image processing is started, in step S141, the input unit 131 of the image processing device 130 receives the encoded data output from the imaging element 100 and transmitted via the bus 121.

In step S142, the interface processing unit 132 executes the interface process to restores the encoded data received in the process of step S141, which have been converted into a format according to the I/O cells, I/O pins, and the like, to the original format and supplies the restored encoded data to the decompression unit 133.

In step S143, the decompression unit 133 executes a decompression process to decompress the encoded data received by the process of step S141 to generate image data.

In step S144, the image processing device 130 performs image processing on the image data obtained by the process of step S143. When the process of step S144 ends, the image processing ends.

### Decompression Process

Next, a decompression process performed in step S142 of FIG. 6 will be described with reference to the flowchart of FIG. 7.

When the decompression process is started, in step S161, the dummy bit removal unit 151 removes the dummy bit inserted into the LSB of the encoded data, and supplies the dummy-bit removed encoded data to the compression rate reverse adjustment unit 152.

In step S162, the compression rate reverse adjustment unit 152 performs reverse adjustment of the compression rate of the encoded data (that is, a reverse process of the process of step S123 of FIG. 6) to restore the Golomb code before the adjustment of the compression rate.

In step S163, the Golomb decoding unit 153 decodes each Golomb code obtained by the process of step S162 to restores the difference value (residual difference) between the pixel data items.

In step S164, the reverse DPCM processing unit 154 performs an inverse DPCM process (that is, an inverse process of the process of step S121 of FIG. 6) by using the difference value (residual difference) obtained by the process of step S163. That is, the reverse DPCM processing unit 154 restores the pixel data items of each unit pixel by, for example, adding difference values to each other.

When the image data is obtained by the process of step S164, the decompression process ends, and the process returns to FIG. 9.

By executing the processes as described above, the image processing device 130 can appropriately decode the encoded data output from the imaging element 100. That is, the image processing device 130 can improve the imaging performance of the imaging element 100 without increasing the cost.

In addition, since it is guaranteed that no prohibition code is generated by adding the dummy bit to the encoded code in the decoding, it is possible to appropriately implement the decoding process.

As a result, it is possible to perform the fixed-length compression of the image data while suppressing the generation of a prohibition code.

Furthermore, although the configuration in which the dummy bit insertion unit 144 is provided in the compression unit 113 and the dummy bit removal unit 151 is provided in the decompression unit 133 has been described above, there may be a configuration where the dummy bit insertion unit 144 is provided in the interface processing unit 114 instead of the compression unit 11 and the dummy bit removal unit 151 is provided in the interface processing unit 132 instead of the decompression unit 133.

By the configuration where the dummy bit insertion unit 144 and the dummy bit removal unit 151 are provided in the interface processing units 114 and 132, respectively, the compression unit 113 and the decompression unit 133 can be used with the configuration in the related art.

### 2. Second Embodiment

Heretofore, the example has been described in which the fixed-length compression is performed by inserting the dummy bit into the encoded data while suppressing the generation of the prohibition code. However, since the dummy bit becomes essential in order to suppress the generation of prohibition code, the compression rate is reduced. Therefore, a compression algorithm itself may suppress the generation of the prohibition code.

### Example of Configuration of Compression Unit in Which Generation of Prohibition Code is Suppressed By Compression Algorithm

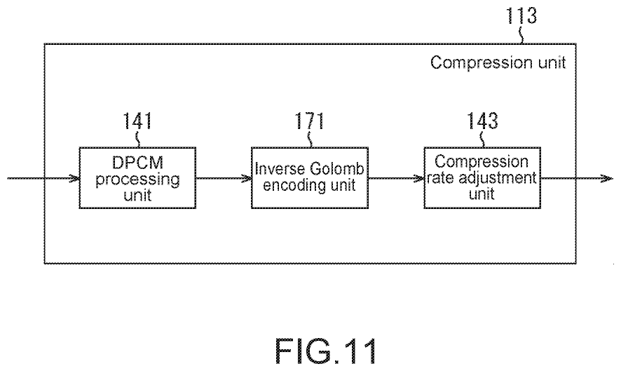

Next, an example of a configuration of the compression unit 113 in which generation of a prohibition code is suppressed by compression algorithm will be described with reference to a block diagram of FIG. 11. Furthermore, the configurations of the imaging element 100 and the image processing device 130 are the same as the configurations described with reference to FIG. 1, and thus, the description will be omitted. In addition, in FIG. 11, the configuration having the same function as the configuration in the compression unit 113 of FIG. 2 will be denoted by the same name and the same reference numeral, and redundant description will be omitted.

That is, the compression unit 113 of FIG. 11 is different from the compression unit 113 of FIG. 2 in that the Golomb encoding unit 142 is replaced by an inverse Golomb encoding unit 171 and the dummy bit insertion unit 144 is deleted.

In the encoding of each difference value (residual difference) supplied from the DPCM processing unit 141 to the Golomb code, the inverse Golomb encoding unit 171 inverts 0's or 1's of the Golomb encoding result according to the value of the LSB of the immediately preceding Golomb encoding to perform the encoding.

That is, for example, when converting the image data to the encoded data by the Golomb encoding unit 142, for example, if the difference value (residual difference) have a state of consecutive 0's, the encoded data has consecutive “1's”. Therefore, if there are a predetermined number or more of consecutive 1's, there is a concern that the code becomes a prohibition code. In addition, for example, if the difference value (residual difference) has a state of consecutive 32's, “0000001000000”, “0000001000000”, . . . are repeated, and thus, there are twelve consecutive “0's”, so that there is a possibly that the code is considered to be a prohibition code.

Therefore, there is a concern that a prohibition code is generated in the Golomb encoding as well.

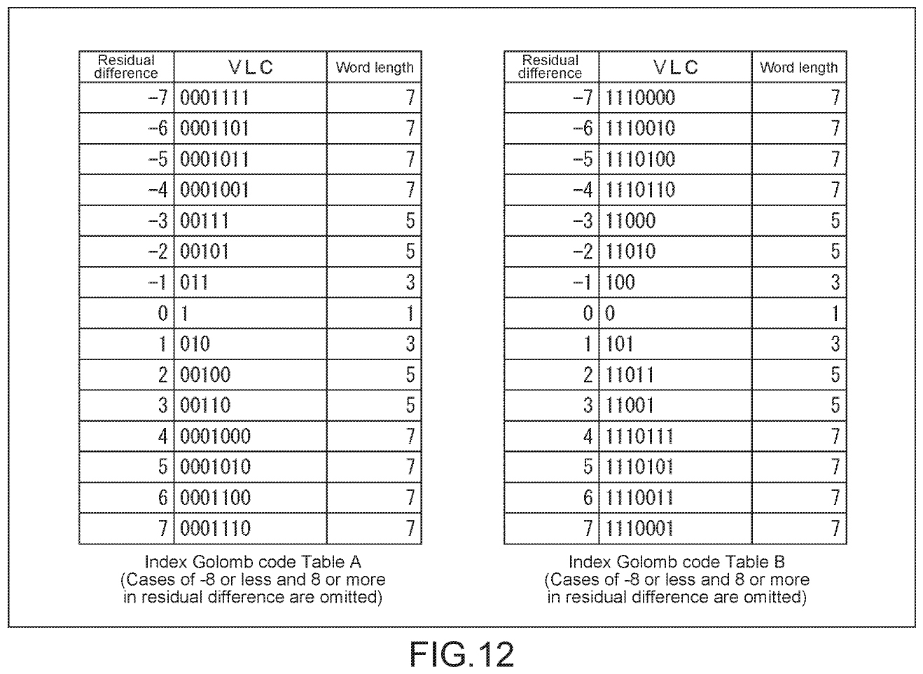

Therefore, the inverse Golomb encoding unit 171 switches and uses the encoded data by normal Golomb encoding, which is set for the difference value (residual difference), as illustrated in the left portion of FIG. 12 and the encoded data obtained by inverting 0's and 1's in the normal encoded data as illustrated in the right portion of FIG. 12 according to the LSB of the immediately preceding encoded data to suppress the generation of the prohibition code.

That is, in a case where the LSB of the immediately preceding encoded data is “1”, the inverse Golomb encoding unit 171 generates the encoded data by the normal Golomb encoding illustrated in the left portion of FIG. 12 (similarly to FIG. 8). In addition, in a case where the LSB of the immediately preceding encoded data is “0”, the inverse Golomb encoding unit 171 generates the encoded data obtained by inverting “0's” and “1's” by the normal Golomb encoding illustrated in the right portion of FIG. 12. Hereinafter, the encoding process of generating the encoded data obtained by inverting “0's” and “1's” by the normal Golomb encoding is also referred to as inverse Golomb encoding.

That is, in a case where the LSB of the immediately preceding encoded data is “0”, the inverse Golomb encoding unit 171 encodes the encoded data to “0” having a word length of 1 when the difference value (residual difference) is 1; the inverse Golomb encoding unit 171 encodes the encoded data (VLC: Variable Length Code) to “101” having a word length of 3 when the difference value (residual difference) is 1; the inverse Golomb encoding unit 171 encodes the encoded data to “11011” having a word length of 5 when the difference value (residual difference) is 2; the inverse Golomb encoding unit 171 encodes the encoded data to “11001” having a word length of 5 when the difference value (residual difference) is 3; the inverse Golomb encoding unit 171 encodes the encoded data to “1110111” having a word length of 7 when the difference value (residual difference) is 4; the inverse Golomb encoding unit 171 encodes the encoded data to “1110101” having a word length of 7 when the difference value (residual difference) is 5; the inverse Golomb encoding unit 171 encodes the encoded data to “1110011” having a word length of 7 when the difference value (residual difference) is 6; and the inverse Golomb encoding unit 171 encodes the encoded data to “1110001” having a word length of 7 when the difference value (residual difference) is 7.

In addition, in a case where the LSB of the immediately preceding encoded data is “0”, the inverse Golomb encoding unit 171 encodes the encoded data (VLC) to “100” having a word length of 3 when the difference value (residual difference) is −1; the inverse Golomb encoding unit 171 encodes the encoded data to “11010” having a word length of 5 when the difference value (residual difference) is −2; the inverse Golomb encoding unit 171 encodes the encoded data to “11000” having a word length of 5 when the difference value (residual difference) is −3; the inverse Golomb encoding unit 171 encodes the encoded data to “1110110” having a word length of 7 when the difference value (residual difference) is −4; the inverse Golomb encoding unit 171 encodes the encoded data to “1110100” having a word length of 7 when the difference value (residual difference) is −5; the inverse Golomb encoding unit 171 encodes the encoded data to “1110010” having a word length of 7 when the difference value (residual difference) is −6; and the inverse Golomb encoding unit 171 encodes the encoded data to “11100 00” having a word length of 7 when the difference value (residual difference) is −7.

Furthermore, in FIG. 12, the encoded data of which difference value (residual difference) is larger than 8 and the encoded data of which difference value is smaller than −8 are omitted. In addition, hereinafter, the normal Golomb encoding based on the table illustrated in the left portion of FIG. 12 is also referred to as “encoding based on the table A”, and the encoding of generating the encoded data by the inverse Golomb encoding based on the table illustrated in the right portion of FIG. 12 is also referred to as “encoding based on the table B”.

Furthermore, in a case where the LSB of the immediately preceding encoded data has one state of “0's” or “1's” being consecutive a predetermined number of times or more, in order to suppress the generation of the prohibition code, when the “encoding based on the table A” is performed immediately before, the inverse Golomb encoding unit 171 switches to the “encoding based on the table B”, and when the “encoding based on the table B” is performed immediately before, the inverse Golomb encoding unit 171 switches to the “encoding based on the table A”.

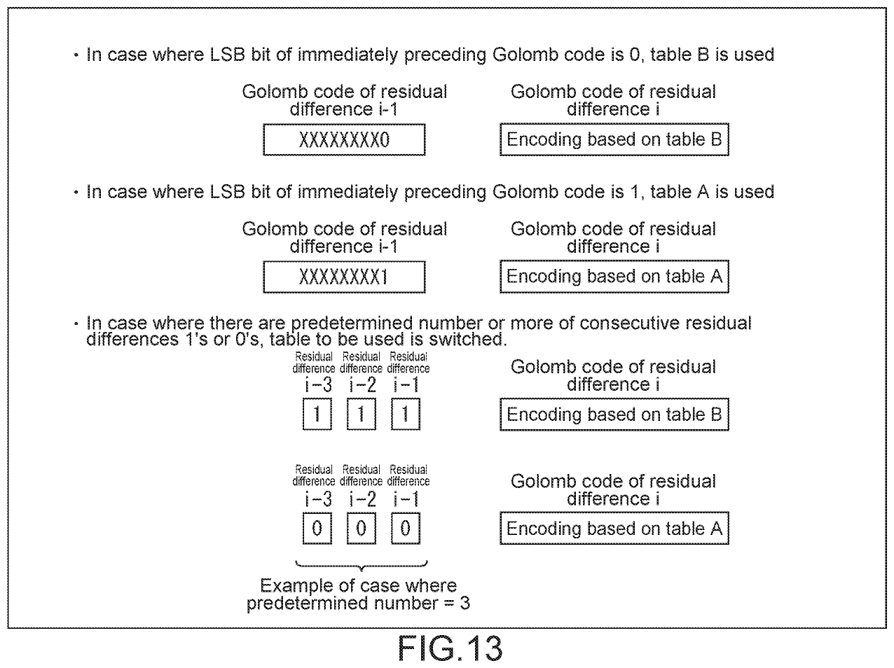

That is, as a summary of the above conditions, the inverse Golomb encoding unit 171 encodes the image data into the encoded data according to the rule as illustrated in FIG. 13.

As illustrated in the uppermost portion of FIG. 13, in a case where the LSB of the immediately preceding Golomb code (Golomb code according to the difference value (residual difference) of the pixel (i−1)) is “0”, the image data is encoded by the encoding based on the table B of FIG. 12. Herein, i denotes an identifier that identifies a pixel that processes image data in the processing order.

In addition, as illustrated in the middle portion of FIG. 13, in a case where the LSB of the immediately preceding; Golomb code (Golomb code according to the difference value (residual difference) of the pixel (i−1)) is “1”, the image data is encoded by the encoding based on the table A of FIG. 12.

Furthermore, as illustrated in the lower portion of FIG. 13, in a case where the LSB of the Golomb code (Golomb code by the difference value (residual difference of the pixel (i−3), (i−2), or (i−1)) has consecutive “1's” a predetermined number of times immediately before (for example, three times in FIG. 13), the image data is encoded by the encoding based on the table B of FIG. 12; and in a case where the LSB of the Golomb code (Golomb code by the difference value (residual difference of the pixel (i−3), (i−2), or (i−1)) has consecutive “0's” a predetermined number of times immediately before (three times in FIG. 13), the image data is encoded by the encoding based on the table A of FIG. 12.

According to such processing, it is possible to realize fixed-length compression of the image data while suppressing generation of a prohibition code.

### Example of Configuration of Decompression Unit in which Generation of Prohibition Code is Suppressed by Compression Algorithm

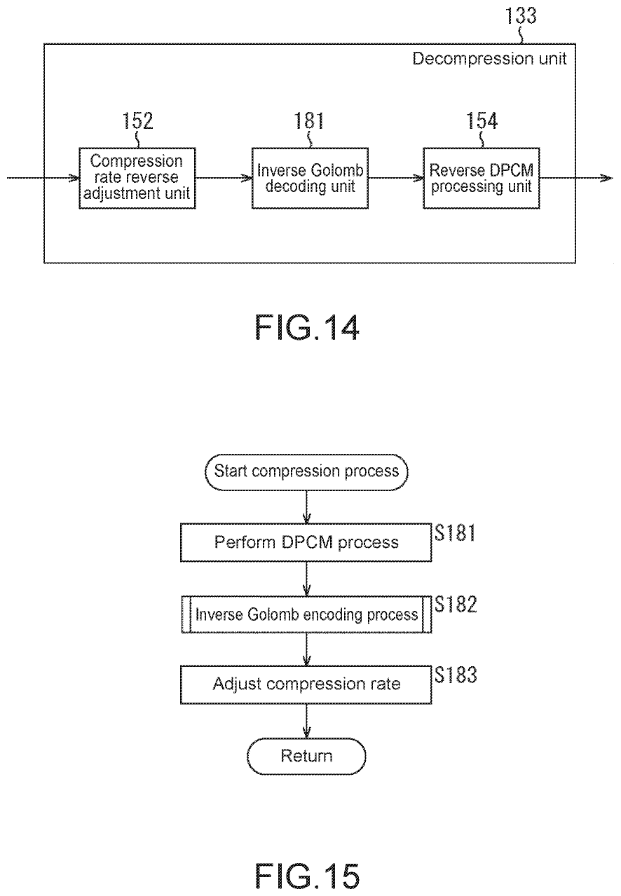

Next, an example of a configuration of the decompression unit 133 in which generation of a prohibition code is suppressed by a compression algorithm will be described with reference to a block diagram of FIG. 14. Furthermore, in FIG. 14, the configuration having the same function as the configuration in the decompression unit 133 of FIG. 4 will be denoted by the same name and the same reference numeral, and redundant description will be omitted.

That is, the decompression unit 133 of FIG. 14 is different from the decompression unit 133 of FIG. 4 in that the dummy bit removal unit 151 is deleted and the Golomb decoding unit 153 is replaced by an inverse Golomb decoding unit 181.

The inverse Golomb decoding unit 181 decodes the Golomb code supplied from the compression rate reverse adjustment unit 152 by a method corresponding to the encoding method of the inverse Golomb encoding unit 171 to restore the difference value (residual difference) generated by the DPCM processing unit 141. The inverse Golomb decoding unit 181 supplies the restored difference value (residual difference) to the reverse DPCM processing unit 154.

### Compression Process

Next, a compression process by the compression unit 113 of FIG. 11 will be described with reference to the flowchart of FIG. 15.

When the compression process is started, in step S181, the DPCM processing unit 141 performs DPCM processing on the image data to obtain a difference value between the pixel data items which is consecutive in the processing order.

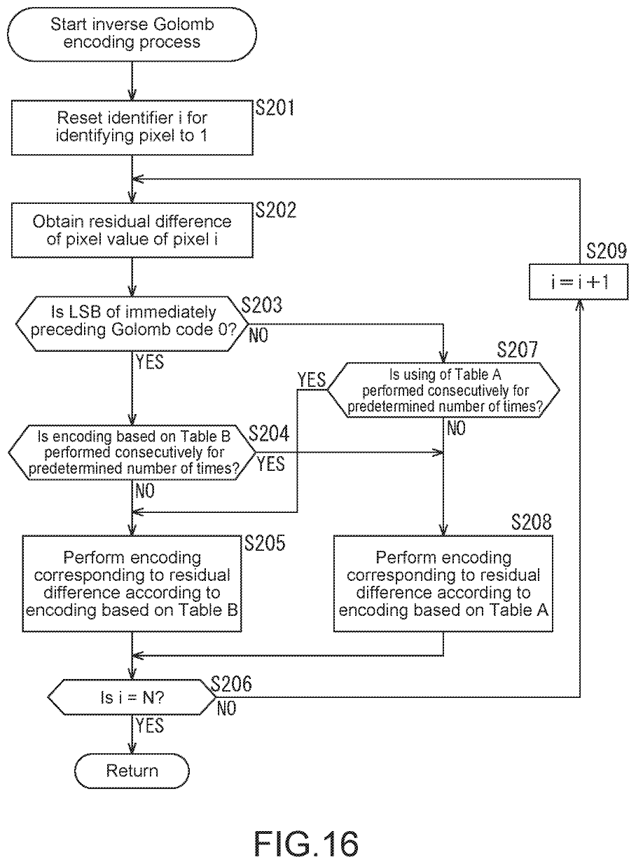

In step S182, the Golomb encoding unit 142 executes the inverse Golomb encoding process described with reference to FIGS. 12 and 13 to encode the image data with each difference value obtained by the process of step S181, Furthermore, the inverse Golomb encoding process will be described later in detail with reference to the flowchart of FIG. 16.

In step S183, the compression rate adjustment unit 143 adjusts the compression rate of the encoded data by, for example, adding a data to the Golomb code obtained by the process of step S182.

When the encoded data with a predetermined compression rate is obtained for the image data input to the compression unit 113 by the process of step S183, the compression process ends.

As described above, by executing the processes, the imaging element 100 can output a larger-capacity data at a higher speed without increasing the cost, and thus, it is possible to improve the imaging performance. In addition, it is possible to perform the fixed-length compression of the image data while suppressing the generation of a prohibition code.

Furthermore, heretofore, the example of determining any one of the “encoding based on table A” or the “encoding based on table B” has been described according to the LSB of the immediately preceding encoded data of the pixel has been described. However, the configuration may be applied to a predetermined bit other than the LSB of the immediately preceding encoded data of the pixel, and the configuration may be applied to, for example, the MSB.

### Inverse Golomb Encoding Process

Next, an inverse Golomb encoding process by the inverse Golomb encoding unit 171 will be described with reference to the flowchart of FIG. 16.

In step S201, the inverse Golomb encoding unit 171 resets a counter of an identifier i for identifying a pixel to 1.

In step S202, the inverse Golomb encoding unit 171 reads out a difference value (residual difference) for a pixel value of the pixel i.

In step S203, the inverse Golomb encoding unit 171 determines whether or not the LSB of the immediately preceding Golomb code is “0”. For example, in a case where the LSB is determined to be “0”, the process proceeds to step S204.

In step S204, the inverse Golomb encoding unit 171 determines whether or not the encoding based on the table B is performed consecutively a predetermined number of times (for example, three times). In a case where it is determined that the encoding is not performed consecutively a predetermined number of times, the process proceeds to step S205.

In step S205, the inverse Golomb encoding unit 171 obtains a Golomb code corresponding to the difference value (residual difference) by the encoding based on the table B, and the process proceeds to step S206.

In step S206, the inverse Golomb encoding unit 171 determines whether or not the counter i indicating the identifier is the number N of pixels, that is, whether or not all the pixels have been encoded. In a case where the counter i is not N, the process proceeds to step S209.

In step S209, the inverse Golomb encoding unit 171 increments the counter i by 1, and the process returns to step S202, and thus, the subsequent processes are repeated.

On the other hand, in a case where it is determined in step S203 that the LSB of the immediately preceding Golomb code is “1”, the process proceeds to step S207.

In step S207, the inverse Golomb encoding unit 171 determines whether or not the encoding based on the table A is performed consecutively a predetermined number of times (for example, three times). In a case where the encoding based on the table A is not performed consecutively a predetermined number of times, the process proceeds to step S208.

In step S208, the inverse Golomb encoding unit 171 obtains the Golomb code corresponding to the difference value (residual difference) by encoding based on the table A, and the process proceeds to step S206.

In step S204, in a case where the encoding based on the table B is performed consecutively a predetermined number of times (for example, 3 times), the process proceeds to step S208.

In addition, in step S207, in a case where the encoding based on the table A is performed consecutively a predetermined number of times (for example, three times), the process proceeds to step S205.

According to the above processes, the encoding based on the table A and the encoding based on the table B are switched according to the LSB of the immediately preceding Golomb code, and when the same encoding is performed consecutively on the LSB of the encoded data, the coding algorithm is switched to encode the image data.

As a result, it is possible to realize fixed-length compression while suppressing generation of a prohibition code.

### Decompression Process by Decompression Unit of FIG. 14

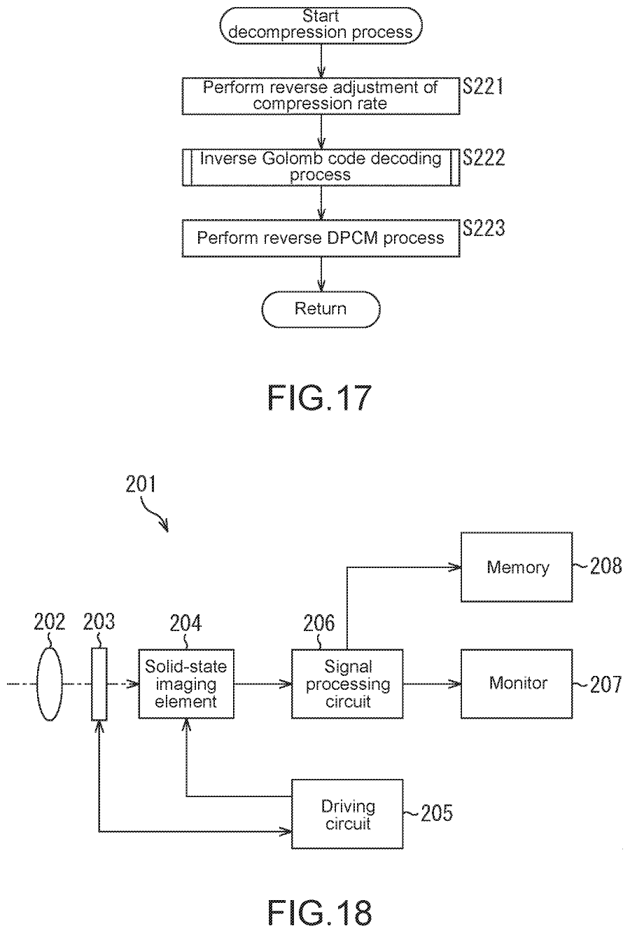

Next, a decompression process by the decompression unit 133 of FIG. 14 will be described with reference to the flowchart of FIG. 17.

When the decompression process is started, in step S221, the compression rate reverse adjustment unit 152 performs reverse adjustment of the compression rate of the encoded data (that is, a reverse process of the process of step S183 of FIG. 15) to restore the Golomb code before the adjustment of the compression rate.

In step S222, the inverse Golomb decoding unit 181 executes an inverse Golomb decoding process to decode each Golomb code obtained by the process of step S221 to restores the difference value (residual difference) between the pixel data items. That is, the inverse Golomb decoding process is a reverse process of the inverse Golomb encoding process described with reference to the flowchart of FIG. 16.

In step S223, the reverse DPCM processing unit 154 performs a reverse DPCM process (that is, a reverse process of the process of step S181 of FIG. 1) using the difference value (residual difference) obtained by the process of step S222. That is, the reverse DPCM processing unit 154 restores the pixel data items of each unit pixel by, for example, adding difference values to each other.

When the image data is obtained by the process of step S223, the decompression process ends.

By executing the processes as described above, the image processing device 130 can appropriately decode the encoded data output from the imaging element 100. That is, the image processing device 130 can improve the imaging performance of the imaging element 100 without increasing the cost.

In addition, by the inverse Golomb decoding process, it is possible to decode the fixed-length-compressed encoded data to acquire the image data while suppressing the generation of a prohibition code.

### 3. Application Example to Electronic Apparatus

The above-mentioned imaging element 100 may be applied to, for example, various electronic apparatuses including imaging apparatuses such as digital still cameras and digital video cameras, mobile phones having imaging functions, or other apparatuses having imaging functions.

FIG. 18 is a block diagram illustrating a configuration example of an imaging apparatus as an electronic apparatus to which an embodiment of the present technology is applied.

An imaging apparatus 201 illustrated in FIG. 18 includes an optical system 202, a shutter apparatus 203, a solid-state imaging element 204, a driving circuit 205, a signal processing circuit 206, a monitor 207, and a memory 208, and is capable of capturing still images and moving images.

The optical system 202 includes one or a plurality of lenses and guides light (incident light) from an object to the solid-state imaging element 204 to form an image on the image receiving surface of the solid-state imaging element 204.

The shutter apparatus 203 is arranged between the optical system 202 and the solid-state imaging element 204 and controls a light irradiation period and a light shielding period to the solid-state imaging element 204 according to the control of the driving circuit 205.

The solid-state imaging element 204 includes a package including the above-mentioned solid-state imaging element. The solid-state imaging element 204 accumulates signal charges for a certain period of time according to the light guided onto the light-receiving surface via the optical system 202 and the shutter apparatus 203. The signal charges accumulated in the solid-state imaging element 204 are transferred according to a driving signal (timing signal) supplied from the driving circuit 205.

The driving circuit 205 outputs driving signals for controlling the transfer operation of the solid-state imaging element 204 and the shutter operation of the shutter apparatus 203 to drive the solid-state imaging element 204 and the shutter apparatus 203.

The signal processing circuit 206 applies various signal processing to signal charges output from the solid-state imaging element 204. An image (image data) obtained when the signal processing circuit 206 applies the signal processing to the pixel signals is supplied to and displayed on the monitor 207 or is supplied to and stored (recorded) in the memory 208.

Also in the imaging apparatus 201 configured as described above, by applying the imaging element 100 and the image processing device 130 instead of the above-described the solid-state imaging element 204 and the signal processing circuit 206, it is possible to perform the fixed-length compression of the image data while suppressing the generation of a prohibition code.

### 4. Usage Example of Imaging Element

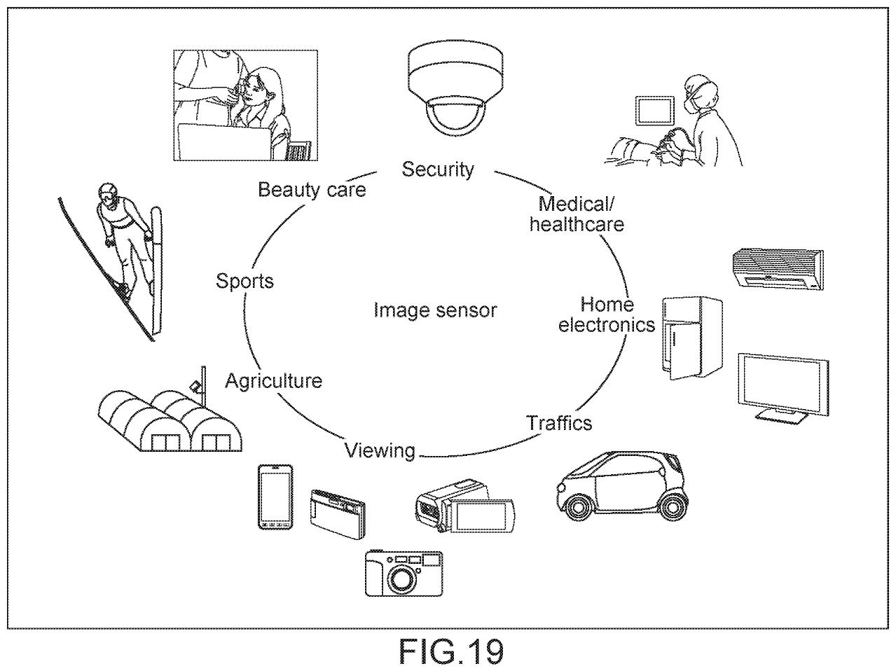

FIG. 19 is a diagram illustrating a usage example of using the above-mentioned imaging apparatus 100.

The above-mentioned imaging element can be used in various cases of sensing light such as visible light, infrared light, ultraviolet light, and X-rays as follows.

An apparatus for photographing images to be viewed, such as a digital camera and a camera-equipped mobile apparatus

An apparatus used for traffic purposes, such as a car-mounted camera that photographs front/rear/periphery/inside of an automobile, a surveillance camera that monitors running vehicles and roads, and a distance measurement sensor that measures distances among vehicles, for safe driving such as automatic stop, recognition of a driver's state, and the like

An apparatus used in home electronics such as a TV, a refrigerator, and an air conditioner, for photographing gestures of users and executing apparatus operations according to the gestures

An apparatus used for medical and healthcare purposes, such as an endoscope and an apparatus that performs blood vessel photographing by receiving infrared light

An apparatus used for security purposes, such as a surveillance camera for crime-prevention purposes and a camera for person authentication purposes

An apparatus used for beauty care purposes, such as a skin measurement apparatus that photographs skins and a microscope that photographs scalps

An apparatus used for sports purposes, such as an action camera and a wearable camera for sports purposes

An apparatus for agriculture purposes, such as a camera for monitoring a state of fields and crops

Furthermore, the present disclosure can also have the following configurations.

<1> An imaging element including:

a light reception unit that receives incident light and performs photoelectric conversion; and

a compression unit that compresses image data obtained in the light reception unit into encoded data not including a prohibition code in which identical codes of which number is more than a predetermined number are consecutively arranged.

<2> The imaging element according t <1>, in which

the compression unit compresses the image data and adds a dummy bit to compress the image data into the encoded data not including the prohibition code in which the identical codes of which number is more than a predetermined number are consecutively arranged.

<3> The imaging element according to <2>, in which

the image data is a set of pixel data items obtained in each unit pixel of the light reception unit,

the compression unit performs Golomb encoding of a difference value between the pixel data items and adds the dummy bit to compress the image data into the encoded data not including the prohibition code.

<4> The imaging element according to <2>, in which

the compression unit compresses the image data at a fixed compression rate and adds the dummy bit to compress the image data into the encoded data not including the prohibition code.

<5> The imaging element according to <1>, in which

the image data is a set of pixel data items obtained in each unit pixel of the light reception unit, and

the compression unit compresses the image data into the encoded data not including the prohibition code by one of Golomb encoding of a difference value between the pixel data items or inverse Golomb encoding of encoding the difference value between the pixel data items to an inverse code for the Golomb encoding on the basis of the encoded data encoded by immediately preceding encoding among the pixel data items.

<6> The imaging element according to <5>, in which

the compression unit compresses the difference value between the pixel data items into the encoded data not including the prohibition code according to one of the Golomb encoding or the inverse Golomb encoding on the basis of a value of a predetermined bit of the encoded data encoded by immediately preceding encoding among the pixel data items.

<7> The imaging element according to <6>, in which

the predetermined bit is a least significant bit (LSB) or a most significant bit (MSB).

<8> The imaging element according to <5>, in which,

in a case where predetermined bits of the encoded data of the difference value between the pixel data items encoded by immediately preceding encoding are identical values being consecutive a predetermined number of times, when the Golomb encoding is performed on the difference value between the immediately preceding pixel data items, the compression unit performs the inverse Golomb encoding, and when the inverse Golomb encoding is performed on the difference value between the immediately preceding pixel data items, the compression unit performs the Golomb encoding to compress the difference value into the encoded data not including the prohibition code.

<9> The imaging element according to any one of <1> to <8>, in which

the prohibition code is a code included in the encoded data, in which 1's or 0's of which number is more than a predetermined number is consecutive.

<10> An imaging method of an imaging element, including a step of:

compressing image data obtained in a light reception unit that receives incident light and performs photoelectric conversion into encoded data not including a prohibition code in which identical codes of which number is more than a predetermined number are consecutively arranged.

<11> An imaging device including:

an imaging element including,

a light reception unit that receives incident light and performs photoelectric conversion, and a compression unit that compresses image data

obtained in the light reception unit into encoded data not including a prohibition code in which identical codes of which number is more than a predetermined number are consecutively arranged; and

a decompression unit that decompresses the encoded data that is output from the imaging element and obtained by compressing the image data by the compression unit.

<12> The imaging device according to <11>, in which

the compression unit compresses the image data and adds a dummy bit to compress the image data into the encoded data not including the prohibition code in which the identical codes of which number is more than a predetermined number are consecutively arranged.

<13> The imaging device according to <12>, in which

the image data is a set of pixel data items obtained in each unit pixel of the light reception unit, and

the compression unit performs Golomb encoding of a difference value between the pixel data items and adds the dummy bit to compress the image data into the encoded data not including the prohibition code.

<14> The imaging device according to <12>, in which

the compression unit compresses the image data at a fixed compression rate and adds the dummy bit to compress the image data into the encoded data not including the prohibition code.

<15> The imaging device according to <11>, in which

the image data is a set of pixel data items obtained in each unit pixel of the light reception unit, and

the compression unit compresses the image data into the encoded data not including the prohibition code by one of Golomb encoding of a difference value between the pixel data items or inverse Golomb encoding of encoding the difference value between the pixel data items to an inverse code for the Golomb encoding on the basis of the pixel data items encoded by immediately preceding encoding among the pixel data items.

<16> The imaging device according to <15>, in which

the compression unit compresses the difference value between the pixel data items into the encoded data not including the prohibition code according to one of the Golomb encoding or the inverse Golomb encoding on the basis of a value of a predetermined bit of the pixel data items encoded by immediately preceding encoding among the pixel data items.

<17> The imaging device according to <16>, in which

the predetermined bit is a least significant bit (LSB) or a most significant bit (MSB).

<18> The imaging device according to <15>, in which,

in a case where predetermined bits of the encoded data of the difference value between the pixel data items encoded by immediately preceding encoding are identical values being consecutive a predetermined number of times, when the Golomb encoding is performed on the difference value between the immediately preceding pixel data items, the compression unit performs the inverse Golomb encoding, and when the inverse Golomb encoding is performed on the difference value between the immediately preceding pixel data items, the compression unit performs the Golomb encoding to compress the difference value into the encoded data not including the prohibition code.

<19> The imaging device according to any one of <11> to <18>, in which the prohibition code is a code included in the encoded data, in which 1's or 0's of which number is more than a predetermined number is consecutively arranged.

<20> An imaging method of an imaging device, including a step of:

decompressing encoded data that is output from an imaging element and obtained by compressing image data by a compression unit, in which

the imaging element includes,

a light reception unit that receives incident light and performs photoelectric conversion; and

the compression unit that compresses the image data obtained in the light reception unit into the encoded data not including a prohibition code in which identical codes of which number is more than a predetermined number are consecutively arranged.

### REFERENCE SIGNS LIST

100 imaging element
101 and 102 semiconductor substrates
111 light reception unit
112 A/D conversion unit
113 compression unit
114 interface processing unit
115 output unit
121 bus
130 image processing device
131 input unit
132 interface processing unit
133 decompression unit
141 DPCM processing unit
142 Golomb encoding unit
143 compression rate adjustment unit
144 dummy bit insertion unit
151 dummy bit removal unit
152 compression rate reverse adjustment unit
153 Golomb encoding unit
154 reverse DPCM processing unit
171 inverse Golomb encoding unit
181 inverse Golomb decoding unit

1. An imaging element, comprising:
a light reception unit that receives incident light and performs photoelectric conversion; and
a compression unit that compresses image data obtained in the light reception unit into encoded data not including a prohibition code in which identical codes of which number is more than a predetermined number are consecutively arranged.

2. The imaging element according to claim 1, wherein
the compression unit compresses the image data and adds a dummy bit to compress the image data into the encoded data not including the prohibition code in which the identical codes of which number is more than a predetermined number are consecutively arranged.

3. The imaging element according to claim 2, wherein
the image data is a set of pixel data items obtained in each unit pixel of the light reception unit, and
the compression unit performs Golomb encoding of a difference value between the pixel data items and adds the dummy bit to compress the image data into the encoded data not including the prohibition code.

4. The imaging element according to claim 2, wherein
the compression unit compresses the image data at a fixed compression rate and adds the dummy bit to compress the image data into the encoded data not including the prohibition code.

5. The imaging element according to claim 1, wherein
the image data is a set of pixel data items obtained in each unit pixel of the light reception unit, and
the compression unit compresses the image data into the encoded data not including the prohibition code by one of Golomb encoding of a difference value between the pixel data items or inverse Golomb encoding of encoding the difference value between the pixel data items to an inverse code for the Golomb encoding on a basis of the encoded data encoded by immediately preceding encoding among the pixel data items.

6. The imaging element according to claim 5, wherein
the compression unit compresses the difference value between the pixel data items into the encoded data not including the prohibition code according to one of the Golomb encoding or the inverse Golomb encoding on a basis of a value of a predetermined bit of the encoded data encoded by immediately preceding encoding among the pixel data items.

7. The imaging element according to claim 6, wherein
the predetermined bit is a least significant bit (LSB) or a most significant bit (MSB).

8. The imaging element according to claim 5, wherein,
in a case where predetermined bits of the encoded data of the difference value between the pixel data items encoded by immediately preceding encoding are identical values being consecutive a predetermined number of times, when the Golomb encoding is performed on the difference value between the immediately preceding pixel data items, the compression unit performs the inverse Golomb encoding, and when the inverse Golomb encoding is performed on the difference value between the immediately preceding pixel data items, the compression unit performs the Golomb encoding to compress the difference value into the encoded data not including the prohibition code.

9. The imaging element according to claim 1, wherein
the prohibition code is a code included in the encoded data, in which 1's or 0's of which number is more than a predetermined number is consecutive.

10. An imaging method of an imaging element, comprising a step of:
compressing image data obtained in a light reception unit that receives incident light and performs photoelectric conversion into encoded data not including a prohibition code in which identical codes of which number is more than a predetermined number are consecutively arranged.

11. An imaging device, comprising:
an imaging element including,
a light reception unit that receives incident light and performs photoelectric conversion, and
a compression unit that compresses image data obtained in the light reception unit into encoded data not including a prohibition code in which identical codes of which number is more than a predetermined number are consecutively arranged; and
a decompression unit that decompresses the encoded data that is output from the imaging element and obtained by compressing the image data by the compression unit.

12. The imaging device according to claim 11, wherein
the compression unit compresses the image data and adds a dummy bit to compress the image data into the encoded data not including the prohibition code in which the identical codes of which number is more than a predetermined number are consecutively arranged.

13. The imaging device according to claim 12, wherein
the image data is a set of pixel data items obtained in each unit pixel of the light reception unit, and
the compression unit performs Golomb encoding of a difference value between the pixel data items and adds the dummy bit to compress the image data into the encoded data not including the prohibition code.

14. The imaging device according to claim 12, wherein
the compression unit compresses the image data at a fixed compression rate and adds the dummy bit to compress the image data into the encoded data not including the prohibition code.

15. The imaging device according to claim 11, wherein
the image data is a set of pixel data items obtained in each unit pixel of the light reception unit, and
the compression unit compresses the image data into the encoded data not including the prohibition code by one of Golomb encoding of a difference value between the pixel data items or inverse Golomb encoding of encoding the difference value between the pixel data items to an inverse code for the Golomb encoding on a basis of the pixel data items encoded by immediately preceding encoding among the pixel data items.

16. The imaging device according to claim 15, wherein
the compression unit compresses the difference value between the pixel data items into the encoded data not including the prohibition code according to one of the Golomb encoding or the inverse Golomb encoding on a basis of a value of a predetermined bit of the pixel data items encoded by immediately preceding encoding among the pixel data items.

17. The imaging device according to claim 16, wherein
the predetermined bit is a least significant bit (LSB) or a most significant bit (MSB).

18. The imaging device according to claim 15, wherein,
in a case where predetermined bits of the encoded data of the difference value between the pixel data items encoded by immediately preceding encoding are identical values being consecutive a predetermined number of times, when the Golomb encoding is performed on the difference value between the immediately preceding pixel data items, the compression unit performs the inverse Golomb encoding, and when the inverse Golomb encoding is performed on the difference value between the immediately preceding pixel data items, the compression unit performs the Golomb encoding to compress the difference value into the encoded data not including the prohibition code.

19. The imaging device according to claim 11, wherein
the prohibition code is a code included in the encoded data, in which 1's or 0's of which number is more than a predetermined number is consecutively arranged.

20. An imaging method of an imaging device, comprising a step of
decompressing encoded data that is output from an imaging element and obtained by compressing image data by a compression unit, wherein
the imaging element includes,
a light reception unit that receives incident light and performs photoelectric conversion, and
the compression unit that compresses the image data obtained in the light reception unit into the encoded data not including a prohibition code in which identical codes of which number is more than a predetermined number are consecutively arranged.
